(19) United States
(12) Patent Application Publication
(10) Pub. No.: US 2009/0016950 A1
(43) Pub. Date: Jan. 15, 2009

(54) Terrestrial lightning-powered magnetic organized single crystal diamond blocks: The forces of nature to form the beautiful gem

(76) Inventor: Reginald Bernard Little, Tallahassee, FL (US)

Correspondence Address: Reginald B. Little, 312 PINEWOOD AVE., ELIZABETH CITY, NC, 27909, US

(21) Appl. No.: 11/810,351

(22) Filed: Jun. 5, 2007

Related U.S. Application Data
(60) Provisional application No. 60/810,858, filed on Jun. 5, 2006.

(51) Int. Cl. C01B 31/06

(52) U.S. Cl. 423/446

(57) ABSTRACT

The new century thrives for the synthesis of larger single crystal diamond blocks for various engineering applications and esthetic marvel. This invention makes use of triggered lightning bolts for instantaneously driving large cross-sections of high electric current density through compresses heated carbonaceous precursor (possibly seeded seed diamond and/or group VIII transition metal catalysts). The said conditions provide huge spin polarized electron motion over large volume for organized magnetization and spin interactions of the lightning bolt with many carbon atoms for the spin induced orbital rehybridization of sp and sp² carbon to sp³ carbon and the voluminous condensation of single diamond crystals.

### FIELD OF THE INVENTION

The present invention involves a method and an apparatus for the synthesis of large single crystal diamond gems. The present invention provides a method for forming highly crystalline diamond of greater than 10 carats. The invention provides a means of producing large diamond carats by use of prior art of the inventor involving strong magnetic phenomena. In the present art, the magnetic field and thermal energy are obtained from the awesome power of tremendous current in lightning bolts. This invention exploits the strong magnetic field within such lightning bolts in conjunction with high pressure in order to stimulate the direct and indirect transformation of graphite and other carbonaceous materials into diamond and also carbon with various catalysts (Fe, Co, Ni and H, and other group VIII transition metals to diamond. The use of such huge electric currents of triggered lightning bolts promote fruitful atomic interactions and processes on the basis of the Little Effect for breaking sp and sp² type carbon bonds and transforming sp² hybridized carbon to sp³ hybridized carbon for diamond crystallization.

### BACKGROUND

The spectacular beauty of diamond has been known since Biblical time. Exodus 28:18, “And the second row shall be an emerald, a sapphire, and a diamond.” Its great hardness exemplified by Jeremiah 17:1 “The sin of Judah is written with a pen of iron, and with the point of a diamond: it is graven upon the table of their heart, and upon the horns of your altars.” Its brilliance and beauty exemplified by Ezekiel 28:13, “Thou hast been in Eden the garden of God; every precious stone was thy covering, the sardius, topaz, and the diamond, the beryl, the onyx, and the jasper, the sapphire, the emerald, and the carbuncle, and gold: the workmanship of thy tabrets and of thy pipes was prepared in thee in the day that thou wast created.”

In 1675, Isaac Newton first as the Father of Physics considered its refractory properties and reasoned it a dense oil. The Father of Chemistry Antoine Lavoisier in 1772 used focused sunlight to burn diamond to CO₂ with lime water testing for determining it pure carbon. H. Guillton in 1779 subsequently determined graphite to also be pure carbon. These determinations of both graphite and diamond as consisting of elemental carbon initiated the Diamond Problem of transforming graphite to diamond. After over 200 years, R. B. Little resolved the diamond Problem in 2001.

In 1880 J. B. Hannay attempted the synthesis of diamond by sealing oil in iron pipes and heating them to red heat in the flames of a fire. Nobel Laureate Moisson in 1893 claimed the formation of diamond by quenching molten iron and sugar cubes that were liquefied by his newly invented electric furnace. C. M. Parson in 1903 attempted to transform graphite to diamond by pressure and electric resistive heating. Nobel Laureate P. W. Bridgman attempted (between 1920-1950) the transformation of graphite to diamond by squeezing and heating with pressures much greater than Parson on the basis of Bridgman's invented high pressure equipment. However, Bridgman was not able to sustain high enough pressure and temperature for bulk diamond formation. Subsequently, independent successes of Eric Lundblad in 1953 and H. T. Hall in 1954 resulted from their prolonged high pressure and high temperature (1200° C. and 75,000 atm) treatment with the added use of iron to catalyze the transformation. In 1963, F. B. Bundy first reported the direct transformation of graphite to diamond at high pressure and high temperatures of 108, 561 and 2000° C. In 1965, Vereshchagin of the Soviet Union subsequently reported the direct formation of diamond from graphite. In 1963, Strong determined the importance of liquid (group VIII, Cr and Mn) transition metal catalysts for catalytic diamond formation. Many researchers have subsequently employed HPHT catalytic processes in order to form larger diamond. Sumiya recently reported 10 carat diamond formation by use of Fe—Co catalyst-solvent with Ti to getter N and Cu to reduce inclusions.

RB Little recently reported the formation of nanodiamond by the magnetization of Fe—C-black at atmospheric pressure. The current invention follows from this prior work of RB Little whereby higher pressures and huge currents and magnetism from lightning bolts are harnesses to enhance the crystallization of diamond.

RB Little in this disclosure has determined and correlated the diamond capacity and volume of world-wide Kimberlite and Lamprosites with the world-wide cloud to ground lightning activity! On this basis RB Little has proposed a new model of diamond formation on the basis of frequent terrestrial lightning striking diamond mines.

The magnetism of lightning bolt has been speculated to cause the discovery of magnetism in ferrites by the ancient Greek and Chinese around the city of Magnesia observed the attraction of iron to these iron oxide stones presumed to have been magnetized by lightning strokes. Ferrites were first discovered thousands of year ago. Large deposits were found in the district of Magnesia in Asia Minor, giving the mineral's name of magnetite (Fe₃O₄).

Benjamin Franklin over 250 years ago determined the electrostatic basis of lightning by flying a kite into a thunder cell and observing the potential difference between the cloud and the ground.

Vladimir Rakov of Lightning Research Center of the University of Florida at Camp Bland and also Joseph Dwyer and Martin Uman of the Florida Institute of Technology have been able to induce lightning strokes from passing thunderclouds by launching a small rocket (3 feet in length) carrying a thin copper coated Kevlar wire string into the charged cloud and distorting the electric field under the cloud for discharge. The technique works 50% of the time.

Vladimir Rakov and others have determined that lightning strokes on silica minerals transforms the minerals to glass. Meteorites and lightning are two natural phenomena known to form glass on earth. Tektite is meteorite glass. Glass formed by lightning is known as Fulgarite, from the Latin word Fulgar, meaning lightning. Nuclear explosions are also known to generate glass on sandy grounds. On the basis of the Little Effect of spin and magnetic induced orbital rehybridization the glass formation is understood. The magnetism induced by the lightning bolt is important in order to induce orbital rehybridization on oxygen (preventing O₂ gas formation) and silica (for sp³ and p¶-d¶ bonding) during the glass formation. The random amorphous glassy condensation is understood here on the basis of the low pressure. The inability of oxygen to form more than two covalent bonds also contributes to the glassy state of the product. Diamond is reasoned here by lightning through compressed carbon on the basis of mechanical background pressure. The tetravalence of carbon is also contributing to the crystallization of diamond during lightning strike as opposed to amorphous condensation. The formation of fulgarite glasses requires currents greater than 50,000 amps. Higher currents generate larger diameter fulgarites. This supports the theory put forth here that the large current of big lightning bolts will for very wide diamond blocks. The length of the fulgarite is also determined by the lightning. The world's largest fulgarite glass was formed by lightning strokes triggered through silica minerals at Camp Blanding, Fla. by Alan McCollum in 1997.

Recently scientists have determined the important role of lightning in forming bulk amounts of Nitrogen Oxides in causing atmospheric chemistry. J. von Liebig first linked lightning to atmospheric nitrogen oxides in 1827.

The lightning bolt contains 10⁹-10¹⁰ joules of energy. Such energy causes temperature rises of over 30,000 K. The temperature of air near a lightning bolt is five times the temperature on the surface of the Sun. Lightning strokes lasts about a few milliseconds although some can linger for significant fractions of seconds. The peak current of powerful bolts can exceed 200,000 amps. The potential across the cloud and the ground can exceed 108 volts.

The magnetization induced in materials hit by lightning bolts has been known for sometime. As noted, it is thought that lighting bolts caused magnetization of magnetite in Asia minor for the first observations of magnetism. Researchers have attempted to determine the current in lightning bolts based on remnant magnetism left in objects struck.

In 1867, V. Verrier and P. Rochette estimated the peak current at ground lightning impacts using remnant magnetization. They determined in 1867 that impact of lightning leaves a permanent record in the struck material by a secondary magnetization called the lightning induced remnant magnetization. On the basis of a schoolyard tree trunk struck by lightning, they were able to determine the position hit and the peak current of about 99000 amps.

Harald Norinder in 1937 considered the remnant magnetization in steel beams of cobalt, nickel, iron and coal steel struck by lightning on steel towers in United States, and Germany in order to observe the large currents in lightning bolts. The measured magnetization of these towers and known magnetic constants allowed calculation of the current of the bolt hitting the tower. Such measurements were done between 1932 and 1936. Maximum currents of 220,000 amps were observed although most bolts had currents less than 100,000 amps.

### BRIEF SUMMARY OF THE INVENTION

One of the improvements of the present invention is an apparatus for providing large diamond carats in high crystalline perfection.

Another improvement of the invention is an apparatus for forming huge diamond blocks with less effort by harnessing the power of nature in the form of lightning bolts. This new art exploits the strong magnetic field, huge electric current and intense thermal energy created by a rocket or laser triggered lightning bolt for forcing the transformation of graphite and other carbon containing precursors to diamond. This new art exploits the lightning bolt for free energy from the forces of nature for eliminating the cost of man-made electricity.

Additional improvements and other features of the present invention will be put forth in the description which follows and in part will be apparent to those having ordinary skill in the art upon examining of the following or may be learned from the practice of the present invention. The progress and improvements of the present invention may be realized and ascertained as outlined in the appended claims.

On the basis of the present invention, the forgoing and other advantages are achieved in part for producing large single diamond crystals. The apparatus consist of a high pressured and heated apparatus having at least one heating element and at least one connection directly to the lightning path for resistance. The heating element can be any element useful for heating the content of the compressed carbon precursor. Catalyst metal and/or diamond seed particles may be mixed with the carbonaceous precursor. At least one device for affecting the pressure on the sample is present. The applied mechanical pressure, heating and the magnetic field and intense resistive heating by the lightning bolt.

In accordance with the current inventive apparatus, a heater is positioned to heat the pressurized vessel containing the carbonaceous precursor to needed temperature from 0° C. to 5000° C.

In accordance with the current inventive apparatus, a pressure generator is attached to the heated carbonaceous precursor. The pressure generator maybe of any variety according to needed pressure requirements of 1 atm to 100 GPa.

In accordance with the current inventive apparatus an electric connection is made between the heated, pressurized carbonaceous precursor and a lightning rod, which is electrically shorted to the base of a charged overhead thunder cell via some triggering mechanism not limited to a small rocket transported copper coated Kevlar wire or an air ionizing laser beam.

In accordance with the current inventive apparatus an electric coil may be wound about the pressurized heated sample with electric connection to the lightning rod such that part of the high current of the lightning bolt is drawn through a Tesla coil for creating a huge magnetic field through the heated, pressurized carbonaceous precursor.

In accordance with the current inventive apparatus, the said magnetized, pressurized heated vessel is contained within a water vessel of liquid nitrogen filled vessel such that after the lightning is triggered the sudden magnetization of the tesla coil causes its explosion and cavitation of the inner walls of the encapsulating cooling vessel for the instant quench of the transformed diamond.

The nature of the carbon precursor used for the synthesis may be different grades of graphite, carbon black, hydrogenated carbon, CNT, fullerenes or nay other carbon containing material. The c axis of crystalline graphite may take any orientation relative to the bolt.

The nature of the catalyst used in the system includes various group VIII transition metals and/or hydrogen.

The inventive method advantageously harnesses the tremendous electric and magnetic energy of the lightning bolt for transforming the carbonaceous precursor to diamond.

Embodiments of the current invention comprise forming diamond by triggering a lightning bolt through and about a compressed heated carbonaceous precursor.

Additional improvements of the present invention will become apparent to those skilled in this art from the following detailed description wherein embodiments of the present invention are described simply by way of illustrated of the best mode contemplated for carrying out the present invention.

### DESCRIPTION OF THE INVENTION

The current invention focuses and resolved various issues associated with the production of large blocks of single-crystal diamond by providing a novel harnessing of the lightning bolt to provide voluminous high electric current density for heating the carbon precursor and a strong magnetic field for enhancing the voluminous rehybridization of sp² carbon to sp³ diamond carbon. The invention is simple in its design. It is however very effective in overcoming the difficulties associated with the voluminous electronic orbital rehybridization of multitudes of carbon atoms from various chemical bond states to the crystalline diamond state on the basis of the Little Effect of spin induced orbital rehybridization of sp² carbon atoms by huge spin polarized electronic motion in the large magnetic field of the lightning bolt and the interactions of this spin polarized current with the carbon atoms over huge space for organized spin induced orbital rehybridization of the carbon atoms to sp³ hybrid state and condensation of huge diamond crystals. The huge current density provides electrons to oversaturate the sp³ carbon to protect it from converting to sp² carbon so it forms diamond rather than graphitic structures.

The current invention eliminates the need for expensive man-generated electricity by using the natural power of lightning. The current invention provides via the high current and magnetic field a large volume of high spin carbon atoms for the favorable crystallization of large blocks of single crystal diamond. Such lower electrical necessity results in lower production cost. In addition, the present invention by the external pressure assists the thermal and magnetization effects of the lightning bolt.

In an embodiment of the current invention, the heating provides a mechanism for increasing the kinetic energy of the atoms of carbon and catalysts. The resistance heating provides a controlled thermal atmosphere for breaking the chemical bonds of the precursor and catalysts for the bond rearrangement to diamond. The heating of the lightning bolt provides more instant high current and resistance heating for more uniformly melting larger cross-sectional areas of carbon for the bond rearrangement over larger area and depth for larger diamond block formation.

The instant current rapidly heats the carbon precursors. The high current density instantly over saturates the carbon atoms for voluminous rehybridization of many carbon atoms from sp² to sp³. The high current density instantly affects all atoms for transformations over large volumes in space. The lightning bolt also delivers an instant magnetic field for organization of the carbon voluminous rehybridization and diamond condensation to large blocks.

Bundy was only able to melt smaller cross-sections and depth over longer time periods relative to the invention here. In the present invention, the lightning bolt more instantaneously pushes high current through the sample. The tremendous power of the lightning bolt allows the instant electrification, magnetization, thermalization, melting of huge volumes of carbon, eliminating the kinetic issues caused by uneven heating, mass transfer, crystallization and resulting bi phasal dynamics encountered by Bundy. The slower and smaller current density and melting zone of Bundy resulted in a narrow central cylindrical volume of molten carbon which transformed to diamond with the surrounding graphene regions cooling the diamond cylindrical core without peripheral enlarge diamond growth. The greater resistance of the formed diamond cylindrical core and its larger thermal conductivity caused difficult melting and electrification of the surrounding unaltered graphite regions of Bundy's synthesis. The use of the lightning bolt resolves these issues of Bundy, because the thunder bolt can deliver more power over greater space for instantly transforming more graphite to diamond relative to the small current and potential employed by Bundy.

Before the lightning bolt is delivered, the precursor is heated to temperatures ( ) 0° C.<T<5000° C.).

During the formation of the diamond, metals of group VIII or hydrogen are employed to catalyze the diamond formation.

In order to assist the diamond crystallization, diamond seed may be employed to facilitate the nucleation and growth of the diamond during the lightning strike.

The apparatus for the production of diamond by the triggered lightning bolt includes a carbonaceous precursor of at least one pressure generator, of at least one heating element and at least one large area electrical connection to the pressurized and heated carbonaceous precursor.

In operation, the carbonaceous precursor is initially compressed and heated within the pressure generator. The carbonaceous precursor is electrically connected to the large cross-sectional lightning rod at one end and also grounded to earth at its other end. The apparatus is set up for operation when prevailing weather conditions appear to generate overhead thunder cells. As the thunder cell moves overhead its potential relative to the ground is monitored until it generates suitable potential difference relative to the ground for lightning strike. At this time a triggering mechanism is used to create a low resistive path for discharge between the cloud and the large lightning rod with the pressurized heated sample in series with the ground. Under these conditions, it is believed that powerful lightning bolts will be harnessed from the cloud of great potential energy and of tremendous current. It is believed that the electrical current (200,000 amps) will flow through the large cross-section lightning rod with large cross-sectional electrical connection with the carbonaceous precursor and then into the electrical ground. It is believed that such instant large cross-sectional current density across large cross-sectional volume of carbonaceous precursor will instantaneously melt, electrify, and magnetize large regions of carbon atoms. It is believed that the resulting molten large volume of magnetically organized carbon and/or metal atoms will under the surrounding pressure crystallize into a single crystal diamond block.

The inventive apparatus can take the physical form in a variety of parts and the arrangement of these parts. In FIG. 1, an apparatus according to the form of the current invention is illustrated. As shown in FIG. 1, the apparatus includes a precursor chamber, a surrounding pressure generator, a heating element and a large cross-sectional electrical contact with a large lightning rod. The large cross-sectional lightning rod is attached to a 2000 ft copper Kevlar string which is attached to a small rocket. The other end of the carbonaceous precursor is attached to the reaction chamber making a large cross-section to the electrical ground. The entire reaction chamber is surrounded by a tank of coolant.

In the form of the current invention the large cross-sectional lightning rod is in electrical contact with a 2000 feet copper coated Kevlar string.

In the form is the current invention, the large cross-sectional lightning rod is in electrical contact with the conductive pressurized carbonaceous chamber.

In the form of the current invention, the conductive pressurized precursor chamber is in large cross-sectional electrical contact with the earth.

In the form of the current invention the pressurized carbon is in contact with a surrounding coolant such that the once the lightning charges the carbon the container melts or explodes so that the coolant instantly quenches the hot pressurized vessel, quenching the diamond.

### EXAMPLE

An apparatus was built by mounting a pressure generator containing carbonaceous (and in some cases group VIII transition metal catalysts or hydrogen) into a rocket launching facility at the Lightning Research Center of The University of Florida. The carbonaceous material is in some cases seeded with diamond micron particles and in some cases with group VIII transition metal catalysts.

The carbon precursor was pressurized to 20 GPa. The pressurized sample was encased by a tank of cooling water and connected to a large lightning rod, which was connected to a small rocket by Cu-kevlar string.

The rocket was shot into a thunder cell triggering a lightning bolt through the pressurized carbonaceous precursor via the Cu coated Kevlar and large lightning rod.

What is claimed:

1. A process for the production of large diamond blocks, said process comprising:
a. Contacting a compressed, heated carbonaceous precursor (possibly containing catalyst and hydrogen) with a large lightning rod and contacting to ground so that a trigger mechanism sends a lightning bolt through the compressed, heated carbon precursor transforming it to diamond blocks
